(19) United States
(12) Patent Application Publication
(10) Pub. No.: US 2026/0287967 A1
(43) Pub. Date: Sep. 24, 2026

(54) OPTICAL ASSEMBLY AND A METHOD FOR REDUCING FORCE INDUCED WAVEFRONT ERRORS

(71) Applicant: OPTOTUNE SWITZERLAND AG, Dietikon (CH)

(72) Inventors: Roman PATSCHEIDER, Dietikon (CH); Christopher LANING, Dietikon (CH); Hagen SCHRAY, Dietikon (CH)

(73) Assignee: OPTOTUNE SWITZERLAND AG, Dietikon (CH)

(21) Appl. No.: 19/472,711

(22) PCT Filed: Apr. 8, 2024
(86) PCT No.: PCT/EP2024/059503

§ 371 Date: Oct. 6, 2025

(30) Foreign Application Priority Data
Apr. 6, 2023 (DE) 10 2023 108 971.4

(51) Int. Cl. G02F 1/29; G02B 3/14; G02B 27/00

(52) U.S. Cl. CPC G02F 1/294; G02B 3/14; G02B 27/0025

(57) ABSTRACT

Optical assembly (1) comprising:—a optical component (2), which comprises two optical surfaces (5, 6) that enclose an internal space (7), which preferably comprises an optical fluid (8);—a compensation component (3), which has at least one adjustable optical property;—an acceleration sensor (9), which is designed to determine an acceleration, in particular gravity, of the optical assembly (1) or a part of the optical assembly;—a control unit (11), which is designed to receive at least one acceleration signal (10) from the acceleration sensor (9) and to control the compensation component (3) in order to adjust the optical property of the compensation component (3) as a function of the acceleration.

### DESCRIPTION

The invention relates to an optical assembly and a method for reducing force induced wavefront errors.

Optical assemblies may be used in various applications to redirect, focus, or refract light beams. It is particularly desirable to be able to variably adjust the optical properties of the optical assembly. For this purpose, the optical assembly may comprise a tunable optical component.

Tunable optical components may comprise two optical surfaces that enclose an internal space, which may be filled with an optical fluid. Deformation of at least one of the surfaces changes the optical properties of the tunable optical component.

Typically, tunable optical components are prone to force—e. g. gravity induced effects, resulting in a deformation of the internal space, which leads to undesired aberrations. For example, force induced coma may occur in applications where liquid lenses are used in non-horizontal orientations, such as in mobile devices, cameras, and microscopes. In these situations, particularly gravitational forces acting on the tunable lens can cause an uneven distribution of the optical fluid between the optical surfaces or sagging of at least one of the optical surfaces. Furthermore, force induced defocus may occur if the pressure of the optical fluid changes due to an acceleration acting on any of the movable masses of the tunable component, i.e. the fluid, the optical surfaces, or another moving part of the tunable optical component. Also, spherical aberrations may occur due to external forces.

Passive compensation of force induced aberrations is possible by providing a liquid chamber, which comprises a further fluid with a different density than the optical fluid. The liquid chamber may be arranged adjacent to the internal space of the tunable optical component along its optical axis. When the tunable optical component is tilted or oriented at an angle, the resulting force, in particular gravity, would cause the internal space to deform. However, the second liquid chamber with the different density creates an opposing force that counteracts the deformation of the internal space of the tunable optical component, reducing the optical aberrations.

This compensation method may be used in liquid lenses for mobile devices and other applications wherein the optical assembly is used for image capturing and gravitational forces can cause a degradation of image quality. However, this type of compensation only allows the compensation of limited kinds of wavefront errors of the optical surfaces of the tunable optical component and requires a lot of installation space.

It is therefore an objective of the invention to provide an optical assembly and a method, that allows a better compensation of force induced aberrations in an optical component.

The objective is solved by an optical assembly according to claim 1 and a method according to claim 17. Preferred embodiments are subjects of dependent claims.

According to the invention, the optical assembly comprises a, in particular tunable, optical component and a compensation component. The tunable optical component comprises two optical surfaces that enclose an internal space, which may comprise an optical fluid. The compensation component has at least one adjustable optical property. The optical assembly further comprises an acceleration sensor, which is designed to determine an acceleration, in particular gravity, of the optical assembly. A control unit is designed to receive at least one acceleration signal from the sensor and to control the compensation component in order to adjust the optical property of the compensation component as a function of the acceleration.

The optical component could be a rigid lens. Every part in the specification and claims which is mentioned with a tunable optical component could be used in a reasonable way without the “tunable” wording.

The invention is based on the idea that in addition to or instead of a adjusting an optical property of the tunable optical component, the compensation component can be used to compensate for the force-induced aberrations of the tunable optical component. Preferably, the compensation component is designed to reduce a wavefront error of the tunable optical component.

As a wavefront error can be considered a deviation from the desired wavefront to the existing wavefront. Components of such a wavefront error are or can be coma, spherical aberration, defocus, tilt, or other Zernike components. The wavefront error could be induced by convection, density, or surface positioning errors. The optical assembly is capable to reduce at least ten percent in particular at least 50 percent and preferably at least 90 percent of the wavefront error related to the desired wavefront.

It is an advantage of the invention that wavefront errors of the tunable optical component are quickly compensated by the compensation component. The compensation component may be designed such that different types of wavefront errors such as coma, defocus and/or spherical aberration may be corrected. Preferably, the compensation component has a translucent or transparent area, in which the compensation component has adjustable optical properties. For example, the compensation component may comprise an adjustable focal length, focal power, polarity, or an adjustable shape that allows the correction of aberrations of the tunable topical component. In particular, the compensation component may comprise a dielectric membrane, a liquid crystal tunable lens, a meta-lens and/or a waveplate lens.

Preferably, the tunable optical component and the compensation component are arranged along an optical axis of the optical assembly. In particular, the compensation component is designed as an integral part of the tunable component, in particular one of the optical surfaces, or as a separate component. In particular, the compensation component is the tunable component.

It is within the scope of the invention that one or more compensation elements are provided which cover the field of view and within this field of view different optical properties are adjustable. Furthermore, multiple compensation components can be arranged along the optical axis to allow adjustment of optical properties.

According to a preferred embodiment of the invention, the optical component is configured to be brought into a default first operational state in which the acceleration corresponds to a first acceleration vector having a predefined (e.g. preferential) first direction, wherein particularly the predefined first direction runs perpendicular to an optical axis of the optical component (e.g. in case when the optical assembly is a near eye system and gravity is typically oriented perpendicular to the horizontal optical axis) or wherein particularly the predefined first direction runs parallel to the optical axis of the optical component (e.g. in case when the optical assembly is a microscope system and gravity typically runs parallel to the vertical optical axis), wherein in an embodiment the at least one acceleration signal is indicative of the predefined first direction and/or wherein in an embodiment the control unit is designed to control the compensation component depending on the spatial orientation of the optical component (e.g. based on the first acceleration vector). Alternatively, particularly in the above, an optical axis of the optical component can be in a pantoscopic tilt, wherein the optical axis is particularly tilted between 0° and 10° from the horizontal axis.

Particularly, the notion near eye system refers to a device positioned close to the eye of the user and particularly worn on the head of a user such as glasses (e.g. for vision correction) or devices for augmented reality (AR) or virtual reality (VR) applications. Here the acceleration, particularly gravity, typically causes a sagging deformation of the optical component (see e.g. above) due to its liquid being drawn downwards by gravity in a direction perpendicular to the (e.g. horizontal) optical axis of the optical component. Furthermore, in case the optical assembly is e.g. a microscope system, the first direction typically runs parallel to the (e.g. vertical) optical axis of the optical component which can also cause deformations of the optical component.

Furthermore, in an embodiment, the optical component is configured to be brought into a second operational state in which the acceleration corresponds to a second acceleration vector, wherein a difference vector between the first acceleration vector and the second acceleration vector has a length of at least 5%, particularly at least 10%, particularly at least 20% of the first acceleration vector or of the second acceleration vector, and wherein in an embodiment the at least one acceleration signal is indicative of the second acceleration vector and/or wherein in an embodiment the control unit is designed to control the compensation component depending on the spatial orientation of the optical component (e.g. based on the second acceleration vector). Here, as an example, the second operational state can be realized in case a person wearing the optical component lowers the head of the person thus generating a different spatial orientation of the optical component and corresponding deviation from the first direction.

Further, according to an embodiment of the invention, the optical component is deformed by the acceleration and induces the wavefront error.

Furthermore, according to yet another embodiment of the invention, a deviation between a wavefront impinging on the optical component and an outgoing wavefront coming from the optical component is reduced by the compensation component, particularly based on the spatial orientation of the optical component. Particularly, the deviation, wherein the deviation can be considered as the maximal error of the outgoing wavefront caused by the optical component, may be reduced by at least 10%, particularly by at least 50%, particularly by at least 90%.

In a preferred embodiment, the compensation component comprises a dielectric membrane.

The dielectric membrane can be designed as thin film. When a voltage is applied across the dielectric membrane, electric charges accumulate on either side of the membrane, creating an electric field. Upon applying a voltage between the membranes, the membranes are attracted or repelled from each other, changing the surface sag of at least one of the membranes along the optical axis. These dielectric membranes can be arranged in such a way, that when excited with a particular voltage, or voltages, the membrane surface sag takes the form of a defocus, astigmatism, tilt, coma, spherical aberration or other Zernike functions or any combination thereof.

Preferably, the dielectric membrane comprises at least one electrode, by which the dielectric membrane is provided with electrical energy, and in particular may be controlled by applying an electric voltage.

Preferably, the tunable optical component is a tunable lens, wherein one of the membranes that enclose the internal space is a dielectric membrane. Preferably, the dielectric membrane is an integral part of the tunable lens and defines one the membranes that enclose the internal space.

Alternatively, the dielectric membrane is attached to one of the optical surfaces of the tunable optical component, preferably on a side facing away from the internal space.

Alternatively, the dielectric membrane may be carried by another optical component, which is arranged along the optical axis of the optical assembly.

Preferably, the compensation component comprises more than one dielectric membrane. Preferably, the membranes are positioned at different locations in order to be able to set spatially different optical properties depending on different voltages. By actuating the dielectric membranes with electrical voltage, the optical properties of the optical assembly may be adjusted with spatial difference.

In another preferred embodiment, the compensation component is designed as a liquid crystal tunable lens.

A liquid crystal tunable lens can be considered a type of lens that uses a liquid crystal material to change its focal length. The lens may be composed of a layer of liquid crystal material sandwiched between two transparent electrodes. By applying a voltage across the electrodes of the liquid crystal lens, the orientation of the liquid crystal molecules can be controlled, which in turn changes the refractive index of the material and thus its focal length. This allows for the lens to be electronically tuned to different focal lengths, making it useful for a variety of applications such as microscopy, imaging, and adaptive optics. Liquid crystal tunable lenses are lightweight, compact, and can easily be integrated with other optical components.

Typically, liquid crystal (LC) tunable lenses work according to an electro-optical effect, i.e. a change in optical properties of a material, in response to an applied electric field. In particular, common LCs are rod-like molecules (so-called nematics), not only having predictable molecular orientations like crystals, but also featuring fluidity like liquids. They typically have a gel-like state, although they can also be solidified (film-like, when polymerized). The orientations of LCs can be controlled by an electric field. This can be used to spatially and dynamically change their effective refractive index for polarized light under a certain angle of incidence. This effect can be exploited to obtain electrically tunable lenses.

Preferably, the liquid crystal tunable lens is attached to one of the optical surfaces or arranged at a distance to one of the surfaces on a side facing away from the internal space.

In a preferred embodiment the compensation component is a meta-lens.

A meta-lens is a type of lens that uses a so-called metamaterial, which is an artificial material with engineered properties, to achieve unprecedented control over light at the nanoscale. Unlike conventional lenses that rely on curved surfaces to refract light, a meta-lens can manipulate light by controlling the phase and amplitude of the electromagnetic waves that pass through it. A meta-lens, which can be used for the invention, is for example described in Advanced Photonics, Vol. 4, Issue 2, 024001 (March 2022), which is referred to in its entirety.

In a preferred embodiment, the compensation component is designed as a waveplate lens.

A waveplate lens, also known as a retarder plate, is an optical component that is used to manipulate the polarization of light passing through it. It may consist of a thin plate made of birefringent material, which means that the speed of light passing through the material depends on its polarization state.

When light passes through a waveplate lens, its polarization is changed in a predictable way depending on the orientation of the plate and its thickness. By designing the waveplate lens, it is possible to create specific polarization states of light that are useful for a variety of applications in optics and photonics.

The waveplate lens may be a half-wave plate, a quarter-wave plate, or a full-wave plate, respectively corresponding to the amount of phase shift that they impose on the light passing through them.

Preferably, the waveplate lens consists of diffractive waveplates and switchable half wave retarders or polarizers configured in such a way that they can switch between 2 or more different configurations, resulting in 2 or more distinct transmitted wavefront shapes. They can for example be created in liquid crystal and liquid crystal polymer materials. Using an electrically switchable liquid-crystal half-wave retarder, switching between focused and defocused beams can for example be realized by the waveplate lens. Other diffractive waveplates and combinations thereof can result in cylindrical or higher order wavefronts.

Preferably, the tunable optical component is a tunable lens, wherein at least one of the optical surfaces is a deformable membrane.

A tunable lens with deformable membranes is a type of tunable optical component that uses thin, flexible membranes that can be deformed to adjust the lens shape and therefore its focal length. The basic design of a tunable lens with deformable membranes typically comprises two flexible membranes sandwiching the optical fluid, which may have gel-like properties.

The membranes are preferably made of a thin, flexible material such as silicone. The optical fluid is typically oil or water, which preferably fills the internal space between the two membranes. A bellow may be arranged between the membranes, enclosing the internal space circumferentially.

It is within the scope of the invention that the tunable optical component comprises an actuator configured to apply one or more forces to one of the membranes, thereby deforming it. For example, the actuator can comprise an electromechanically adjustable ring, which is at least partially in contact with one of the membranes and by whose adjustment the internal space can be deformed. However, the invention is not limited to an embodiment of a tunable optical component comprising such an actuator.

In a preferred embodiment the acceleration sensor is designed as an inertial measurement unit and/or an accelerometer. In particular, the acceleration sensor is a piezoelectric sensor or in particular a MEMS sensor, which can measure the acceleration directly.

An inertial measurement unit (IMU) may be an electronic device that measures accelerations acting on it and/or its angular rate and in some cases also its orientation. It is typically composed of an accelerometer, typically a 3-axis accelerometer, and/or a gyroscope, preferably a 3-axis gyroscope, and may include a magnetometer, preferably a 3-axis magnetometer, to detect the orientation relative to the earth magnetic field.

Piezoelectric sensors work on the principle of piezoelectricity, where certain materials generate an electric charge in response to mechanical stress or vibrations. Typically, a piezoelectric crystal is used to measure an acceleration with at least one measurement axis. Preferably, the acceleration sensor comprises three measurement axes.

The accelerometer may be a capacitive accelerometer that uses the principle of capacitance, where the capacitance between two conductive plates changes with acceleration. They are highly sensitive and accurate.

In a preferred embodiment, the acceleration sensor comprises an image sensor, which is designed to measure the result of the acceleration force based on aberrations of an image of the image sensor.

According to the further embodiment described above, the acceleration is not measured directly but indirectly, based on a captured image. Such an indirect measurement is advantageous because direct measurement may be subject to measurement uncertainties due to e.g. temperature variations. Compared to direct measurement methods, the advantageous optical measurement is less prone to external influences, such as temperature changes. It is possible, for example, to use methods of digital image processing with which the acceleration can be determined as a function of an imaging error.

Preferably, the acceleration sensor is designed as a spatial tracking module. This allows the acceleration to be determined based on the deformation of the tunable optical component or preferably one of its membranes.

A spatial tracking module uses sensors to determine its movement and orientation in a 3-dimensional space. When for example using an “inside-out” scheme, one or multiple cameras are used to observe features in the environment. This data is then used to determine the precise position and motion of the device in its environment, preferably in combination with IMU data. Another possible implementation of a spatial tracking module uses one or multiple cameras mounted in the environment, observing features on the device to determine its precise position and motion.

Preferably the control unit comprises a calculation model, wherein said control unit converts the determined acceleration to an estimated wavefront error of the optical component and/or said control unit determines a compensation wavefront for the compensation component. In particular, the control unit does not need to be physical connected to the optical component.

The wavefront error of the optical assembly can be a coma, a defocus, or a spherical aberration. The compensation wavefront can have a wavefront error compensating configuration.

The calculation model preferably comprises a predictive model, that is in particular based on a mechanics and/or a fluid dynamics model of the tunable component. Preferably, the predictive model allows the prediction of a wavefront error even before it occurs depending on the determined acceleration alone.

In a simple embodiment, the calculation module comprises a look-up table.

According to the invention, the method for reducing an acceleration force induced, in particular gravity-induced, aberration for an optical assembly comprises the following steps:
measuring directly or indirectly an acceleration force acting on the optical component of the optical assembly by an acceleration senor of the optical assembly,
changing an optical property of the optical active module in relation to the acceleration force.

Preferably, the method can be carried out by means of the optical assembly according to the invention or a preferred embodiment thereof. Preferably, the optical assembly is designed to carry out the method according to the invention or one of its preferred embodiments. With regard to the advantages achievable with the process, reference is therefore made to the explanations concerning the optical assembly according to the invention.

In a simple embodiment, the method may be performed by measuring an acceleration, in particular, gravity directly with an accelerometer or indirectly via position and orientation sensing, with a spatial tracking system. Based on a determined acceleration, in particular an acceleration vector, a correction signal is calculated by the control unit, e.g. via a lookup table, an analytical function or based on calibration data. A control signal is then sent to the compensation component, which induces a change to its transmitted/reflected wavefront, counteracting the optical aberrations that this acceleration is causing in itself or elsewhere in the system.

For example, a voltage is applied on one or more dielectric electrodes arranged in such a way that a deformation of said membrane is generated, generating the desired wavefront change.

In a preferred embodiment, the method comprises a calculation step, which takes place between the measuring step and the changing step and is performed by a control unit of the optical assembly and correlates the measured acceleration force to a signal for the compensation component of the optical assembly.

Preferably, while changing the optical property, a wavefront error of the optical assembly is reduced, wherein the wavefront error is comprising components of coma, defocus, or a spherical aberration.

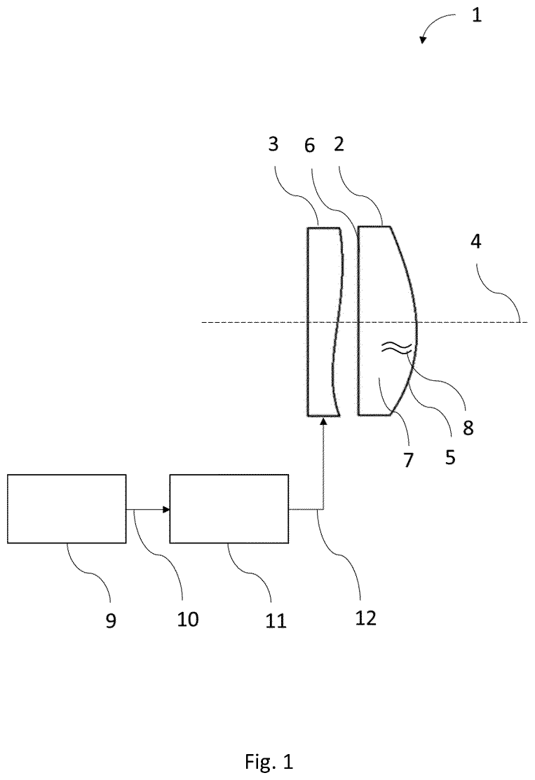

The invention is explained below by way of example with reference to FIG. 1.

FIG. 1 shows an optical assembly.

For better understanding, the reference numerals as used in the FIG. 1 are listed below with their corresponding feature.
1—Optical assembly
2—Tunable optical component
3—Compensation component
4—Optical axis
5—First membrane
6—Second membrane
7—Internal space
8—Optical fluid
9—Acceleration sensor
10—Acceleration signal
11—Control unit
12—Control signal

FIG. 1 shows an optical assembly with a tunable optical component 2 and a compensation component 3 that are arranged along an optical path 4 of the optical assembly.

According to FIG. 1, the tunable optical component 1 is a tunable lens, which comprises two membranes that enclose an internal space, which is filled with an optical fluid. The membranes are deformable and each define a transparent area which is impinged by the optical path 4.

The tunable lens 2 is a type of lens whose focal length can be adjusted to allow for variable magnification and focus. Tunable lenses have adjustable optical properties. In the embodiment shown in FIG. 1, the optical properties of the tunable optical component 2 are adjustable by deforming one of its membranes by an actuation means (not shown). The actuation means comprises a ring like actuation element that is electromechanically displaceable in order to deform one of the membranes to change an optical property of the tunable optical component 2.

Tunable lenses are generally prone to force-in particular gravity induced effects, resulting in a deformation of the internal space 7. For example, force induced coma may occur in applications where liquid lenses are used in non-horizontal orientations, such as in mobile devices, cameras, and microscopes. In these situations, particularly gravitational forces acting on the tunable lens can cause an uneven distribution of the optical fluid between the membranes, which is accompanied by a corresponding deformation of the membranes.

Thus, the force or the acceleration leads to a wavefront error, which can be understood as an undesired deformation of at least one of the membranes 5 or 6 that leads to an aberration.

If the optical assembly 1 is to be used in an image acquisition system, such imaging errors are undesirable. For this reason, the optical assembly 1 has compensation component 3, by means of which it is possible to compensate for the aberration.

According to the embodiment shown in FIG. 1, the compensation component 5 is a liquid crystal tunable lens. However, in an alternative embodiment, this may be a dielectric membrane, a metal lens, or a waveplate lens, preferably depending on the kind of aberration that shall be compensated.

An acceleration sensor 9 determines an acceleration of the optical module and communicates an acceleration signal 10 to a control unit 11. The control unit 11 comprises a calculation module, by means of which the determined acceleration is converted to an estimated wavefront error of the liquid lens. Furthermore, the calculation module determines a compensation wavefront for the compensation component and provides a control signal 12 in order to set the desired compensation wavefront.

1. Optical assembly (1) comprising:
a, in particular tunable, optical component (2), which comprises two optical surfaces (5, 6) that enclose an internal space (7), which preferably comprises an optical fluid (8);
a compensation component (3), which has an adjustable optical property;
an acceleration sensor (9), which is designed to determine an acceleration, in particular gravity, of the optical assembly (1) or a part of the optical assembly;
a control unit (11), which is designed to receive at least one acceleration signal (10) from the acceleration sensor (9) and to control the compensation component (3) in order to adjust the optical property of the compensation component (3) as a function of the acceleration.

2. Optical assembly (1) according to claim 1, wherein the tunable optical component (2) is a tunable lens and wherein at least one of the optical surfaces (5, 6) is a deformable membrane.

3. Optical assembly (1) according to claim 1, wherein the acceleration sensor (9) is designed as an inertial measurement unit and/or an accelerometer.

4. Optical assembly (1) according to claim 1, wherein the acceleration sensor comprises an image sensor, which is designed to measure the result of the acceleration force based on aberrations of an image of the image sensor.

5. Optical assembly (1) according to claim 1, wherein the compensation component (3) is designed in order to reduce a wavefront error.

6. Optical assembly (1) according to claim 5, wherein the optical component (2) comprises a default first operational state in which the acceleration corresponds to a first acceleration vector having a predefined first direction, wherein particularly the predefined first direction runs perpendicular to an optical axis (4) of the optical component (2) or runs parallel to an optical axis (4) of the optical component (2), wherein particularly the at least one acceleration signal is indicative of the first acceleration vector.

7. Optical assembly (1) according to claim 6, wherein the optical component (2) comprises a second operational state in which the acceleration corresponds to a second acceleration vector, wherein a difference vector between the first acceleration vector and the second acceleration vector has a length of at least 5%, particularly of at least 10%, particularly of at least 20% of the first acceleration vector or of the second acceleration vector, and wherein particularly the at least one acceleration signal is indicative of the second acceleration vector.

8. Optical assembly (1) according to claim 5, wherein the optical component (2) is deformed by the acceleration and induces the wavefront error.

9. Optical assembly (1) according to claim 1, wherein a deviation between a wavefront impinging on the optical component (2) and an outgoing wavefront coming from the optical component (2) is reduced by the compensation component (3).

10. Optical assembly (1) according to claim 1, wherein the compensation component (3) comprises an active surface, in particular a dielectric membrane, which in particular defines at least one of the optical surfaces of the tunable component.

11. Optical assembly (1) according to claim 1, wherein the compensation component (3) is designed as a liquid crystal tunable lens.

12. Optical assembly (1) according to claim 1, wherein the compensation component (3) is designed as a meta lens.

13. Optical assembly (1) according to claim 1, wherein the compensation component (3) is designed as a waveplate lens.

14. Optical assembly (1) according to claim 1, wherein the control unit (11) comprises a calculation module, wherein said control unit (11) converts the determined acceleration to an estimated wavefront error of the optical component and/or said control unit (11) generates the control signal for adjusting an optical property of the compensation component (3) for compensating the wavefront error.

15. Optical assembly (1) according to claim 14, wherein the calculation module is configured to use a model of mechanics and/or fluid dynamics.

16. Optical assembly (1) according to claim 14, wherein the calculation module comprises a look-up table.

17. Method for reducing an acceleration force induced, in particular gravity-induced, aberration for an optical assembly (1), preferably according to claim 1, comprising the following steps:
measuring directly or indirectly an acceleration of the optical component of the optical assembly by an acceleration senor of the optical assembly,
changing an optical property of the optical assembly, in particular a compensation component, in relation to the acceleration force.

18. Method according to claim 17, comprising a calculation step, which takes place between the measuring step and the changing step and is performed by a control unit (11) of the optical assembly and correlates the measured acceleration force to a signal received by compensation component (3) of the optical assembly.

19. Method according to claim 17, wherein while changing the optical property, a wavefront error of the optical assembly is reduced.
